(19) United States
(12) Patent Application Publication
(10) Pub. No.: US 2026/0332529 A1
(43) Pub. Date: Oct. 22, 2026

(54) CONGESTION CONTROL IN A MULTI-POINT-TO-MULTI-POINT COMMUNICATIONS NETWORK

(71) Applicant: Telefonaktiebolaget LM Ericsson (publ), Stockholm (SE)

(72) Inventors: Harald GUSTAFSSON, LUND (SE); Johan EKER, LUND (SE); Fredrik SVENSSON, LOBEROD (SE); Per SKARIN, LUND (SE)

(21) Appl. No.: 19/486,716

(22) PCT Filed: May 30, 2023
(86) PCT No.: PCT/SE2023/050532

§ 371 Date: Nov. 21, 2025

(51) Int. Cl. H04L 47/125

(52) U.S. Cl. CPC H04L 47/125

(57) ABSTRACT

Methods and devices for supporting congestion control in a multi-point-to-multi-point communications network comprising two or more sender network nodes and two or more receiver network nodes. A computing device (101) obtains (201) information about congestion of two or more network node pairs, each network node pair comprising a sender network node of the two or more sender network nodes and a receiver network node of the two or more receiver network nodes. The information about congestion is based on a congestion indication comprised in packets transmitted between the sender network node and the receiver network node. The computing device generates (203) and (205) transmits to each sender network node of each network node pair, a data transmission rate value for each sender network node of each network node pair, and/or a load balance weight for each of the two or more network node pairs based on the information about congestion.

### TECHNICAL FIELD

The invention relates to a method for supporting congestion control in a multi-point-to-multi-point (MP2MP) communications network, the method performed by a computing device, a method for supporting congestion control in an MP2MP communications network, the method performed by a receiver network node, a computing device for supporting congestion control in an MP2MP communications network, a receiver network node for supporting congestion control in an MP2MP communications network, and corresponding computer programs, computer-readable data carriers, and data carrier signals.

### BACKGROUND

Software applications deployed in data centers are typically developed based on a microservice architecture. In the microservice architecture, an application is built as a set of microservices (also called services), wherein each microservice performs a specific function or task by running its own processes independently from the other microservices. Therefore, if a microservice fails, it does not escalate into an application-wide outage. A further advantage of the microservice architecture is scalability. Since the microservices are independently deployable, they can be scaled up or down based on the microservice demand.

The microservices are loosely coupled, i.e., the microservices have minimum knowledge about each other, and any change to one microservice should not affect the other microservices. However, in order to execute its own processes, a microservice might request data from other microservices. When multiple microservices try to communicate with each other, network congestion and latency problems may occur.

### SUMMARY

It is an object of the invention to provide an improved alternative to the above techniques and prior art. More specifically, it is an object of the invention to provide improved congestion control in a multi-point-to-multi-point (MP2MP) communications network. This and other objects of the invention are achieved by means of different aspects of the invention, as defined by the independent claims. Embodiments of the invention are characterized by the dependent claims.

According to a first aspect of the invention, there is provided a method for supporting congestion control in a MP2MP communications network comprising two or more sender network nodes and two or more receiver network nodes. The method is performed by a computing device. The method comprises obtaining information about congestion of two or more network node pairs. Each network node pair comprises a sender network node of the two or more sender network nodes and a receiver network node of the two or more receiver network nodes. The information about congestion of a network node pair of the two or more network node pairs is based on a congestion indication. The congestion indication is comprised in packets transmitted between the sender network node and the receiver network node of the network node pair. The congestion indication is obtained from the receiver network node. The method further comprises determining a data transmission rate value for each sender network node of each network node pair, and/or a load balance weight for each of the two or more network node pairs based on the information about congestion of the two or more network node pairs. The load balance weight for a network node pair indicates a portion of a total traffic of the sender network node of the network node pair to be transmitted by the sender network node to the receiver node of the network node pair. The method further comprises transmitting the data transmission rate value and/or the load balance weight to each sender network node of each of the two or more network node pairs.

According to a second aspect of the invention, there is provided a method for supporting congestion control in a MP2MP communications network. The method is performed by a receiver network node of a network node pair of the MP2MP communications network. The method comprises generating information about congestion of the network node pair. The information about congestion of the network node pair is based on a congestion indication comprised in packets transmitted between the sender network node and the receiver network node of the network node pair. The method further comprises transmitting the information about congestion to a computing device.

According to a third aspect of the invention, there is provided a computing device for supporting congestion control in a MP2MP communications network comprising two or more sender network nodes and two or more receiver network nodes. The computing device comprises a processor and a memory. The memory has stored thereon instructions executable by the processor. The instructions, when executed by the processor, cause the computing device to obtain information about congestion of two or more network node pairs. Each network node pair comprises a sender network node of the two or more sender network nodes and a receiver network node of the two or more receiver network nodes. The information about congestion of a network node pair of the two or more network node pairs is based on a congestion indication. The congestion indication is comprised in packets transmitted between the sender network node and the receiver network node of the network node pair. The information about congestion is obtained from the receiver network node. The instructions, when executed by the processor, cause the computing device to determine a data transmission rate value for each sender network node of each network node pair, and/or a load balance weight for each of the two or more network node pairs based on the information about congestion. The load balance weight for a network node pair indicates a portion of a total traffic of the sender network node of the network node pair to be transmitted by the sender network node to the receiver node of the network node pair. The instructions, when executed by the processor, cause the computing device to transmit the data transmission rate value and/or the load balance weight to each sender network node of each network node pair.

According to a fourth aspect of the invention, there is provided a receiver network node of a network node pair of a MP2MP communications network. The MP2MP communications network comprises two or more sender network nodes and two or more receiver network nodes. The receiver network node comprises a processor and a memory. The memory has stored thereon instructions executable by the processor. The instructions, when executed by the processor, cause the receiver network node to generate information about congestion of the network node pair. The information about congestion of the network node pair is based on a congestion indication comprised in packets transmitted between the sender network node and the receiver network node of the network node pair. The instructions, when executed by the processor, cause the receiver network node to transmit the information about congestion to a computing device.

According to a fifth aspect of the invention, there is provided a computer program comprising instructions which, when run in a processing unit of a computing device, cause the computing device to perform the method according to the first aspect of the invention.

According to a sixth aspect of the invention, there is provided a computer-readable data carrier having stored thereon the computer program according to the fifth aspect of the invention.

According to a seventh aspect of the invention, there is provided a data carrier signal carrying the computer program according to the fifth aspect of the invention.

According to an eighth aspect of the invention, there is provided a computer program comprising instructions which, when run in a processing unit of a receiver network node, cause the receiver network node to perform the method according to the second aspect of the invention.

According to a ninth aspect of the invention, there is provided a computer-readable data carrier having stored thereon the computer program according to the eighth aspect of the invention.

According to a tenth aspect of the invention, there is provided a data carrier signal carrying the computer program according to the eighth aspect of the invention.

### BRIEF DESCRIPTION OF THE DRAWINGS

For better understanding of the present disclosure, and to show more readily how the invention may be carried into effect, reference will now be made, by way of example, to the following drawings, in which:

FIG. 1a illustrates a scenario involving a computing device for supporting congestion control according to embodiments of the invention, multiple forwarding network nodes, two microservices of an application comprising multiple instances (or replicas) and corresponding network proxies, wherein the network proxies are transmitters and receivers of a multi-point-to-multi-point (MP2MP) communications network according to embodiments of the invention;

FIG. 1b shows a further example scenario involving two worker machines of an overlay network, each worker hosting a container runtime, two pods, network interfaces, and a module with functionality for supporting congestion control and a computing device for supporting congestion control according to embodiments of the invention;

FIG. 2 shows a flow chart illustrating a method performed by a computing device for supporting congestion control in an MP2MP communications network, according to embodiments of the invention;

FIG. 3a shows an example of a feedback control system for determining data transmission rate and/or a load balance weight, according to embodiments of the invention;

FIG. 3b shows an example of a first lookup operation for determining data transmission rate as used by embodiments of the invention;

FIG. 3c shows an example of a second lookup operation for determining a load balance weight as used by embodiments of the invention;

FIG. 4 shows a flow chart illustrating a method performed by a receiver network node of an MP2MP communications network for supporting congestion control in the MP2MP communications network, according to embodiments of the invention;

FIG. 5 shows message exchanges between an instance of a microservice A of an application, a first network proxy, forwarding network nodes, a second network proxy according to embodiments of the invention, an instance of a microservice B of the application, and a computing device according to embodiments of the invention;

FIG. 6a shows an example of congestion scenario in a receiver network node of an MP2MP communications network;

FIG. 6b shows how a computing device for supporting congestion control according to embodiments of the invention manages the congestion scenario shown in FIG. 6a;

FIG. 7 is a block diagram depicting a computing device according to embodiments of the invention; and

FIG. 8 is a block diagram depicting a receiver network node according to embodiments of the invention.

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

Microservice architecture is an architectural approach for building applications as a collection of independently deployable and loosely coupled microservices (also called services). A downside of the loose coupling is that it is often hard to debug and tune the entire application comprising all the microservices, since the microservices have minimum (inter)dependencies with each other. For example, it is non-trivial to configure connection timeouts and re-transmissions in case of timeout and/or failed transmission.

A service mesh is a dedicated infrastructure layer built into the application, which allows to control how microservices share data with one another. A service mesh is an array of network proxies (also known as sidecars) which are executed in parallel with the corresponding microservices or corresponding instances (or replicas) of the microservice of the application. An instance or replica of a microservice of an application is an execution unit. Instances or replicas of a microservice can to a large degree interchangeably handle work assigned to the microservice. An instance or replica is for example a pod in a Kubernetes cluster. All network traffic received and sent by each microservice or instance is routed through the corresponding network proxy. The network proxy provides functionalities, such as discovering of new microservices or instances, network traffic managing, filtering (through network policies), monitoring (up to Open Systems Interconnection (OSI) layer 7), load balancing, and encryption. The service mesh may be represented as a multi-point-to-multi-point (MP2MP) communications network, wherein the network proxies are the nodes of the MP2MP communications network. An MP2MP communications network is a communications network comprising two or more sender network nodes and two or more receiver network nodes. A sender network node of the two or more sender network nodes may be connected to one or more receiver network nodes of the two or more receiver network nodes. A receiver network node of the two or more receiver network nodes may be connected to one or more sender network nodes of the two or more sender network nodes. A sender network node of the two or more sender network nodes forms with each of the one or more receiver network nodes to which it is connected, a network node pair. The sender network node and the receiver network node of a network node pair are connected via one or more forwarding network nodes. The two or more sender network nodes are interchangeable with each other, and the two or more receiver network nodes are interchangeable with each other. In other words, any of the two or more sender network nodes may be used to transmit the same data and any of the two or more receiver network nodes may be used to receive the data. Therefore, in case of congestion on a network node pair, a further network node pair can be selected to exchange the data.

A microservice or instance might request/transmit data from/to other microservices or instances. When the microservices or instances communicate with each other, queuing may occur at one or more of the microservices or instances and/or at the corresponding network proxy. Queuing at the network proxies may also occur because of further traffic not generated by the microservices or instances. Queues may cause (traffic) congestion and generate delay, packet loss, and/or blocking of new connections.

The invention disclosed herein makes it possible to improve congestion control in an MP2MP communications network comprising two or more sender network nodes and two or more receiver network nodes. The MP2MP communications network may be a service mesh or an overlay network. The two or more sender network nodes and the two or more receiver network nodes may be network proxies of the service mesh, or nodes of the overlay network.

The congestion control is implemented obtaining information about congestion of two or more network node pairs. Each network node pair comprises a sender network node of the two or more sender network nodes, and a receiver network node of the two or more receiver network nodes. Information about congestion of a network node pair of the two or more network node pairs is based on a congestion indication comprised in packets transmitted between the sender network node and the receiver network node of the network node pair.

The method further comprises determining a data transmission rate value for each sender network node of each network node pair, and/or a load balance weight for each of the two or more network node pairs based on the information about congestion. The load balance weight for a network node pair indicates a portion of a total traffic of the sender network node of the network node pair to be transmitted by the sender network node to the receiver node of the network node pair. The method further comprises transmitting the data transmission rate value and/or the load balance weight to each sender network node of each of the two or more network node pairs.

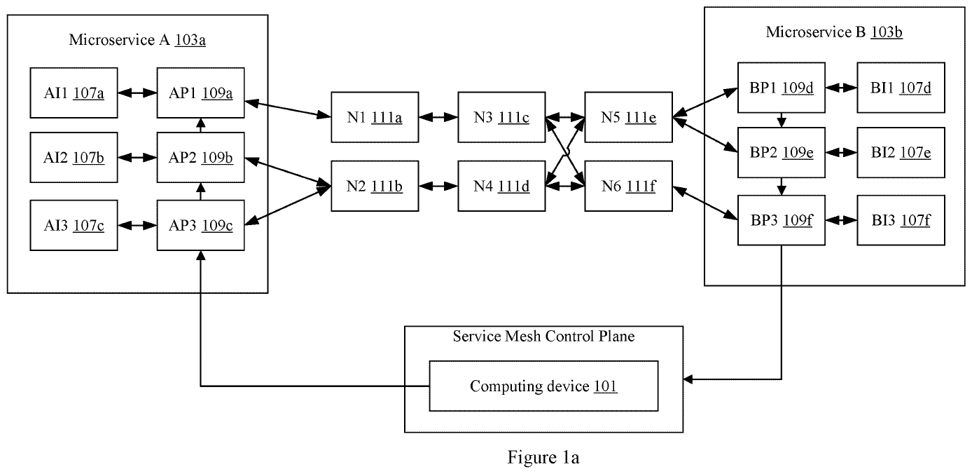

FIG. 1a shows an example of an MP2MP communications network comprising
three sender network nodes (AP1 109a, AP2 109b, AP3 109c), and
three receiver network nodes (BP1 109d, BP2 109e, BP3 109f).

The three sender network nodes (AP1-3 109a-c) may be network proxies of a service mesh of a (microservice) application. Each of the three sender network nodes (AP1-3 109a-c) is paired with a corresponding instance (AI1 107a, AI2 107b, AI3 107c) of a microservice A 103a of the application. The three receiver network nodes (BP1-3 109d-f) may be three further network proxies of the service mesh of the application, wherein each of the three receiver network nodes (BP1-3 109d-f) is paired with a corresponding instance (BI1 107d, BI2 107e, BI3 107f) of a microservice B 103b of the application.

FIG. 1a also shows:
six forwarding network nodes (N1-6 111a-f) connecting the three sender network nodes (AP1-3 109a-c) to the three receiver network nodes (BP1-3 109d-f); and
a computing device (also referred to as (global) congestion controller) 101. The computing device 101 communicates with the network proxies (AP1-3 109a-c, BP1-3 109d-f) of the service mesh.

The following network node pairs may be identified in FIG. 1a:
Pair 1 (P1): AP1-BP1 connected via the forwarding network nodes N1, N3, N5;
Pair 2 (P2): AP1-BP2 connected via the forwarding network nodes N1, N3, N5;
Pair 3 (P3): AP1-BP3 connected via the forwarding network nodes N1, N3, N6;
Pair 4 (P4): AP2-BP1 connected via the forwarding network nodes N2, N4, N5;
Pair 5 (P5): AP2-BP2 connected via the forwarding network nodes N2, N4, N5;
Pair 6 (P6): AP2-BP3 connected via the forwarding network nodes N2, N4, N6;
Pair 7 (P7): AP3-BP1 connected via the forwarding network nodes N2, N4, N5;
Pair 8 (P8): AP3-BP2 connected via the forwarding network nodes N2, N4, N5;
Pair 9 (P9): AP3-BP3 connected via the forwarding network nodes N2, N4, N6.

The computing device 101 obtains information about congestion of the nine network node pairs (P1-P9). The information about congestion for each network node pair may be obtained from the receiver network node (BP1-3 109d-f) of each network node pair. The computing device 101 determines a data transmission rate value for each sender network node (AP1-109a-c) of each network node pair, and/or a load balance weight for each of the two or more network node pairs (P1-P9) based on the information about congestion. In other words,
AP1 receives a data transmission rate value that it will use to send data to BP1, BP2, and BP3, and/or three load balance weights to use to distribute the data towards BP1, BP2, and BP3, respectively,
AP2 receives a data transmission rate value that it will use to send data to BP1, BP2, and BP3, and/or three load balance weights use to distribute the data towards BP1, BP2, and BP3, respectively,
AP3 receivers a data transmission rate value that it will use to send data to BP1, BP2, and BP3, respectively, and/or three load balance weights use to distribute the data towards BP1, BP2, and BP3, respectively.

If, for example, there is a congestion on the link between the forwarding network nodes N3-N5, the computing device 101 will update
the load balance weights of AP1 towards BP1 and BP2 (i.e., of the network node pairs P1 and P2) to a lower value compared to the current one, and
the load balance weights of AP1 towards BP3 (i.e., of the network node pair P3) to a higher value compared to the current one, since there is probably available bandwidth towards BP3.

In this way, AP1 would produce the same amount of data and the corresponding instance IA1 would not need to implement a backpressure mechanism, i.e., a congestion control mechanism, such as generated data reduction or buffering the generated data by the sender network node. Similarly, if there is a congestion on the link between the forwarding network nodes N1-N3, the computing device 101 will update the data transmission rate of AP1 to a lower value compared to the current one, since the only path out (N1-N3) from AP1 is experiencing congestion. In this case, the corresponding instance IA1 would need to implement a backpressure mechanism. Since a reduction of the data transmission rate could result in lower quality of service, the computing device 101 may further update the data transmission rate of AP3 to a higher value compared to the current one. In this way, the higher load of AP3/AI3 may compensate the lower load of AP1/AI3, and the quality of service may thereby be maintained.

The MP2MP communications network may alternatively be an overlay network for container network technologies, i.e., a virtual or logical network connecting multiple nodes, wherein the nodes are for example workers, such as Kubernetes workers. The overlay network is created on top of (overlays) a host-specific network. The overlay network handles routing of packets between workers. Therefore, each of the two or more sender network nodes and each of the two or more receiver network nodes may be a worker of the overlay network.

FIG. 1b shows an example of an overlay network comprising two workers 121a-b (worker1 and worker2) communicating via a network 130, each worker hosting a container runtime 125a-b (like Docker), two pods 123a-b, 123c-d (pod1 and pod2 in worker1, and pod3 and pod4 in worker2), network interfaces 129a-b, and a module called “OverlayNetwork” 127a-b with functionalities for supporting congestion control, and a computing device 101 for supporting congestion control according to embodiments.

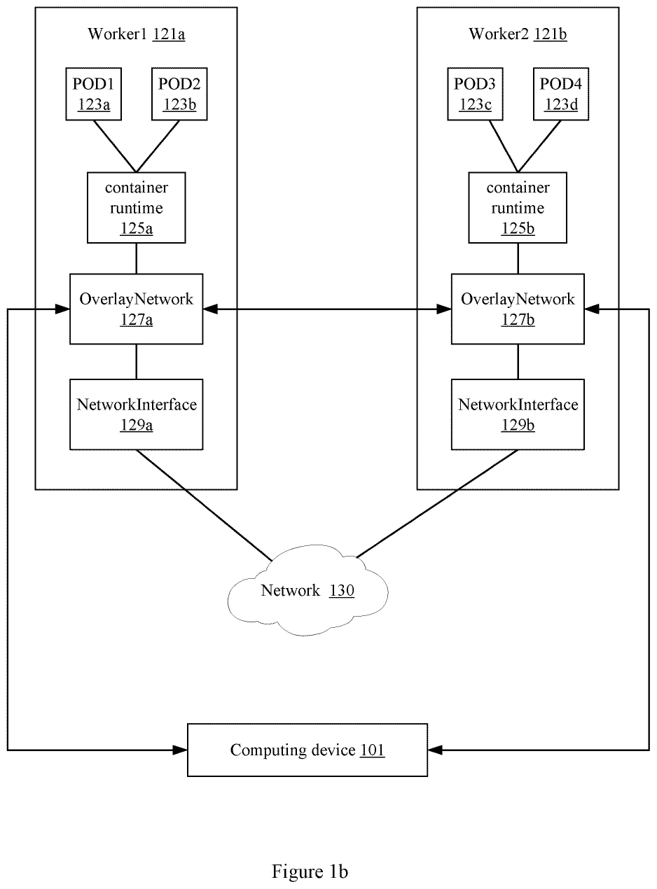

FIG. 2 shows a method 200 for supporting congestion control in an MP2MP communications network.

The MP2MP communications network comprises two or more sender network nodes and two or more receiver network nodes. The MP2MP communications network may be a service mesh, or an overlay network as described above. The two or more sender network nodes and the two or more receiver network nodes may be network proxies of the service mesh. Each network proxy is coupled with a microservice of an application. Each of the two or more sender network nodes may be a network proxy of the service mesh coupled with an instance of a first microservice of the application. Further, each of the two or more receiver network nodes may be a network proxy of the service mesh coupled with an instance of a second microservice of the application. All the data received and sent by each microservice is routed through the corresponding network proxy. Alternatively, the two or more sender network nodes and the two or more receiver network nodes may be network nodes of the overlay network.

The method 200 is performed by a computing device (also referred to as (global) congestion controller) 101.

The method 200 comprises obtaining information about congestion of two or more network node pairs. Each network node pair comprises a sender network node of the two or more sender network nodes and a receiver network node of the two or more receiver network nodes.

Information about congestion of a network node pair of the two or more network node pairs is based on a congestion indication. The congestion indication is comprised in one or more packets transmitted between the sender network node and the receiver network node of the network node pair. The information about congestion of the network node pair may be obtained by the computing device 101 from the receiver network node of the network node pair.

The congestion indication comprised in a packet of the one or more packets transmitted from the sender network node to the receiver network node of the network node pair, may be comprised in one or more bits of the packet. The congestion indication comprised in the packet may comprise Low Latency, Low Loss, Scalable Throughput (L4S) or Explicit Congestion Notification (ECN) bit values in the packet. The one or more bits of the packet may be set (or “marked”) to a predetermined value by one or more forwarding network nodes that forwards the packet from the sender network node to the receiver network node of the network node pair, if the one or more forwarding network nodes experience congestion when the packet travers them. The purpose of marking the packet (called “marked packet”) is to inform the receiving network node of an impending congestion. For example, a forwarding network node of the one or more forwarding network nodes may mark a received packet (i.e., a packet of the one or more packets sent by the sender network node to the receiver network node of the network node pair) if the packet queue length of the forwarding network node is higher than a threshold.

The information about congestion of the network node pair may comprise a congestion level associated with the traversal of the packets between the sender network node and the receiver network node of the network node pair. The congestion level may be determined by the receiver network node of the network node pair. The congestion level may be indicative of a fraction of packets received by the receiving network node from the sender network node of the network node pair, wherein each packet belonging to the fraction of packets comprises a congestion indication indicating that the packet has been forwarded by one or more forwarding network nodes that experienced congestion. In other words, the packets comprised in the fraction of packets are “marked packets”. The congestion level may be a percentage value. For example, if the receiving network node receives one “marked packet” out of 10 received packets, the receiving network node determines a congestion level of 10%.

The method further comprises determining, based on the information about congestion of the two or more network node pairs,
a data transmission rate value for each sender network node of each of the two or more network node pairs, and/or
a load balance weight for each of the two or more network node pair.

Since the computing device 101 obtains the information about congestion for each of the two or more network node pairs, the computing device 101 can determine the data transmission rate value for each sender network node of each network node pair and/or the load balance weight for each network node pair based on a (global) knowledge of the congestion situation in the MP2MP communications network, without necessarily knowing the topology of the MP2MP communications network.

The data transmission rate value for each sender network node of each network node pair indicates the number of bits, bytes, packets, messages, requests, or connections, that the sender network node is allowed to transmit during a certain time period. The data transmission rate may be expressed in terms of a maximum value. An example of data transmission rate value may be 1,000 megabits per second (Mbps).

The load balance weight for a network node pair indicates a portion of total traffic (in terms of bits, bytes, packets, messages, requests, or connections) of the sender network node of the network node pair to be transmitted by the sender network node to the receiver node of the network node pair. In other words, if a sender network node is connected to two or more receiver network nodes (therefore corresponding two or more network node pairs may be identified, wherein the two or more network node pairs have a same sender network node), the total traffic sent by the sender network node is distributed among the two or more receiver network nodes, i.e., among the two or more network node pairs sharing same sender network node. The portion of traffic transmitted to each of the receiver network nodes connected to the sender network node depends on the load balance weight assigned to the network node pair to which the receiver network node belongs. For example, with reference to FIG. 1a and specifically to the network node pairs P1, P2, and P3, if the load balance weights are used in a weighted round-robin load balancer technique, and the values of the load balance weights assigned to each network node pair are, for example, 5 for P1, 3 for P2, and 1 for P3, the network sender node AP1 will forward the first five requests along P1, the next three requests along P2, the next request along P3, the next 5 request along P1, and so on.

The method 200 further comprises transmitting the data transmission rate value and/or the load balance weight to each sender network node of each network node pair. Each sender network node will then update the data transmission rate value and/or the load balance weight of each network node pair and transmit the data based on the received data transmission rate value and/or load balance weight.

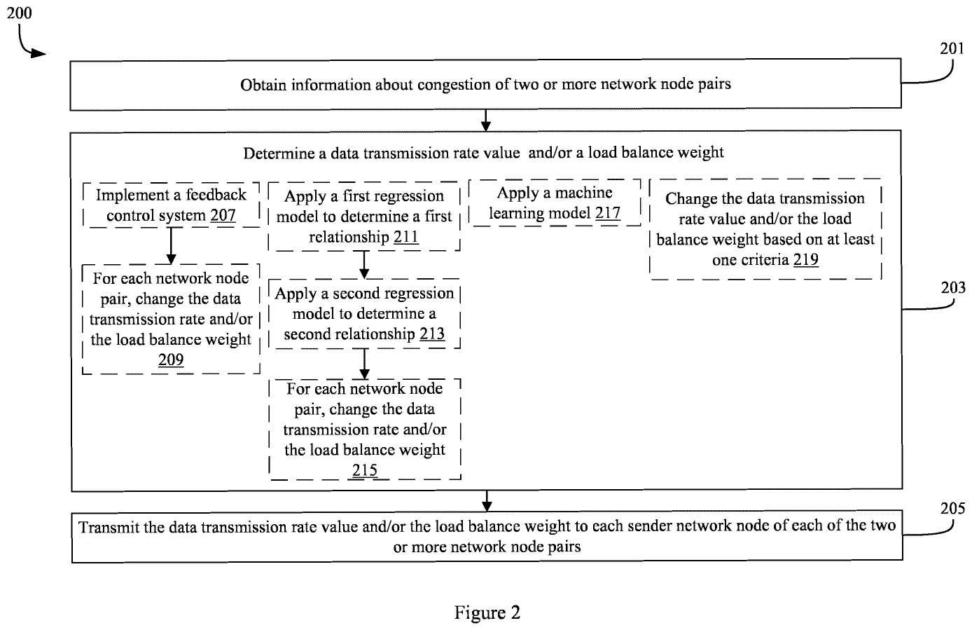

The determination of the data transmission rate value for each sender network node of each network node pair and/or the load balance weight for each of the two or more network node pairs may further comprise implementing a feedback control system 300. A feedback control system example is shown in FIG. 3a.

A feedback control system may be implemented for each network node pair of the two or more network node pairs. Each feedback control system may comprise a data rate controller 301, a weight controller 303, and a plant 305. The plant 305 is the system to be controlled and comprises:
a network node pair i,
one or more forwarding network nodes connecting sender network node and receiver network node of the network node pair,
information about congestion of the network node pair,
further performance indicators (e.g., latency, throughput) associated with the network node pair.

The data-rate controller 301 takes as input:
a value indicating a first threshold associated with a performance parameter (i.e., a first target value), such as a pre-defined congestion level, p_{ref}, of the network node pair,
a current (measured) value of the performance parameter of the network node pair, e.g., the current congestion level p of the network node pair, and
a current load balance weight of the network node pair.

An objective of the data-rate controller is to regulate the congestion level p(t) to be at p_{ref} (i.e., minimize the error between p(t) and p_{ref}) by changing the data transmission rate of the sender network node of the network node pair. The output of the data rate controller is the data transmission rate of the sender network node, u(t), obtained as

u(t)=c(t)+v(t), wherein
c(t) is the data receiving rate b(t) of the receiver network node (i.e., the number of bits, bytes, packets, messages, requests, or connections, that the receiver network node receives during a time period) delayed by d, i.e., c(t)=b(t−d) and
v(t) is a value proportional to the error e(t) between p(t) and p_{ref} (i.e., e(t)=p_{ref}−p(t)), obtained as v(t)=K(pref−p(t)), wherein K is a control parameter.
   Moreover, the input of the plant is a(t)=u(t−d), (i.e., the data transmission rate u(t) of the sender network node delayed by d). Note that in the general case the delays need not to be identical.

The weight controller 303 takes as input the current congestion level p(t) for each network node pair i and a value indicating a second threshold associated with the performance parameter (i.e., a second target value), such as a maximum congestion level pₘₐₓ. The weight controller 303 updates the load balancing weight of the network node pair if p(t) exceeds the second threshold. The updating of the load balancing weight may be implemented for example by steering the traffic of the sender network node to receiver network nodes which are less congested (and not overloaded).

The determination of the data transmission rate value for each sender network node of each network node pair and/or a load balance weight for each of the two or more network node pairs may alternatively comprise applying a regression model to determine:
a first function that describes a first relationship between two or more receiver network nodes of two or more network node pairs sharing a same sender network node and the congestion level of the two or more network node pairs, and/or
a second function that describes a second relationship between two or more sender network nodes of two or more network node pairs sharing a same receiver network node and the congestion level of the two or more network node pairs.

The determination may further comprise changing the data transmission rate value for the sender network node of each of the two or more network node pairs sharing the same sender network node, based on the first function, and/or changing the load balance weight for each of the two or more network node pairs sharing the same receiver network node, based on the second function.

If, for example, the first function shows that the congestion level is similar for all the network node pairs sharing the same sender network node, the computing device 101 may decrease the value of the data transmission rate. If, for example, the second function shows that the congestion level is different for all the network node pairs sharing the same receiver network node, the computing device 101 may update the value of the load balance weight for each of the network node pairs sharing the same receiver network node by reducing the load balance weight for the network node pairs with higher congestion level and increasing the load balance weight for the network node pairs with lower congestion level.

The changing of the data transmission rate value for the sender network node of each of the two or more network node pairs sharing the same sender network node may be performed by a first lookup operation. The input of the first lookup operation comprises congestion levels associated with the two or more node network pairs sharing the same sender network node. The output of the first lookup operation is the data transmission rate for the (same) sender network node. Changing the load balance weight for each of the two or more network node pairs sharing the same receiver network node based on the second relationship may be performed by a second lookup operation. The input of the second lookup operation comprises congestion levels associated with the two or more node network pairs sharing the (same) receiver network node. The output of the second lookup operation is the load balance weight for each sender network node connected to the (same) receiver network node.

FIG. 3b shows an example of inputs and output of a first lookup operation. In the example of FIG. 3b, a sender network node Sᵢ is connected to m receiver network nodes (R₁, . . . , Rₘ), therefore m network node pairs can be identified. The first lookup operation takes as input m congestion levels for the m network node pairs. The output of the first lookup operation is the data transmission rate for the sender network node Sᵢ.

FIG. 3c shows an example of inputs and output of a second lookup operation. In the example of FIG. 3b, n sender network nodes (S₁, . . . , Sₙ) are connected to a same receiver network node Rⱼ, therefore n network node pairs can be identified. The second look up operation takes as input n congestion levels for the n network node pairs. The output of the second lookup operation is a load balance weight for each network node pair.

The determination of the data transmission rate for each sender network node of each network node pair and/or a load balance weight for each of the two or more network node pairs may alternatively comprise applying a machine learning model for adjusting the data transmission rate for each sender network node and/or the load balance weight for each of the two or more network node pairs. For example, the machine learning model may be a reinforcement learning model, wherein:
the environment comprises the two or more network node pairs;
a state of the environment comprises the congestion level of the two or more network node pairs;
the action space comprises “increasing load balancing weights”, “decreasing load balancing weights”, “increasing data transmission rate”, “decreasing data transmission rate”; and
the reward may be based on response time and/or transfer time of packets from sender network node and receiver network node of the two or more network node pairs.

The determination of the data transmission rate value for each sender network node of each network node pair and/or the load balance weight for each of the two or more network node pairs may alternatively comprise changing the data transmission rate value and/or the load balance weight based on at least one of:
a congestion threshold condition, wherein if the congestion level associated with a network node pair fulfills the congestion threshold condition, the data transmission rate value of the sender network node of the network node pair and/or the load balance weight of the network node pair is/are changed;
a first rule for increasing or decreasing the data transmission rate value and/or a second rule for increasing or decreasing the load balance weight;
a frequency indicating how often to change the data transmission rate value and/or the load balance weight;
a maximum and/or minimum value of the data transmission rate value and/or the load balance weight; and
a priority associated with each of the two or more sender network nodes indicating an order in which the data transmission rate values of the two or more sender network nodes are changed, and/or a priority associated with each of the two or more network node pairs indicating an order in which the load balance weights of the two or more network node pairs is/are changed.

It will be appreciated that the method 200 may comprise additional, alternative, or modified, steps in accordance with what is described throughout this disclosure.

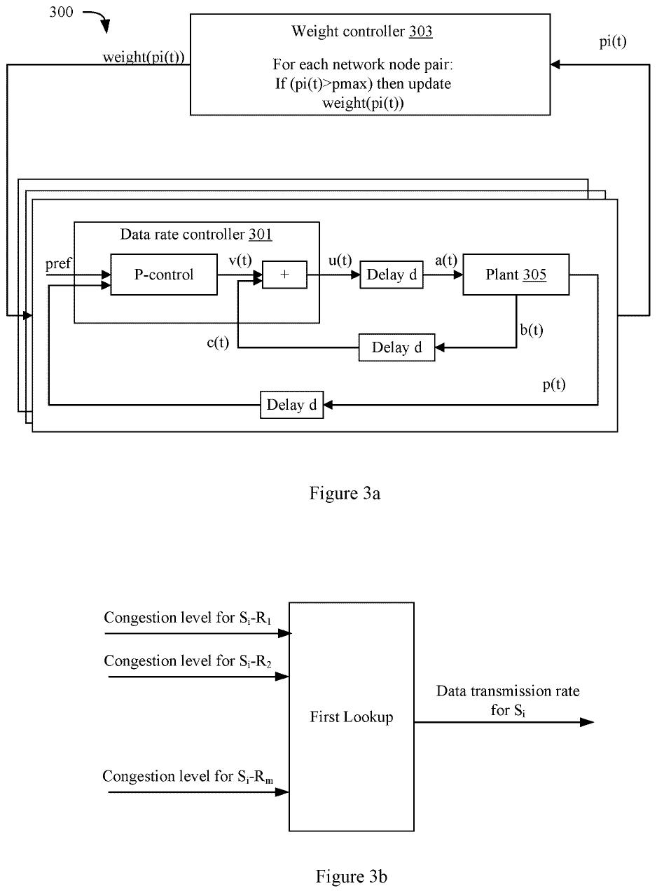

FIG. 4 shows a method 400 for congestion control in an MP2MP communications network. The MP2MP communications network may be a service mesh or an overlay network. An example of service mesh is Istio. An example of overlay network in Kubernetes is implemented by Container Network Interface (CNI) plugins. The method 400 may be performed by a receiver network node of a network node pair of the MP2MP communications network. The network node pair comprises a sender network node of the MP2MP communications network and the receiver network node. The receiver network node may be a router, gateway, IoT gateway, or any device with computing, storage, and network connectivity. The receiver network node may be a network proxy of the service mesh or a network node of the overlay network. The network proxy is executed in parallel with a corresponding microservice or instance of a microservice of an application. All the data received and sent by the microservice or by the instance is routed through the network proxy.

The method 400 comprises determining information about congestion of the network node pair of the MP2MP communications network (i.e., the network node pair comprising the receiver network node performing the method 400). If the receiver network node is comprised in two or more network node pairs, the receiver network node may determine information about congestion for each of the two or more network node pairs.

The information about congestion of the network node pair is based on a congestion indication. The congestion indication is comprised in one or more packets transmitted between the sender network node and the receiver network node of the network node pair. The congestion indication may be comprised in one or more bits of one or more packets transmitted from the sender network node to the receiver network node of the network node pair. The congestion indication may comprise L4S or ECN bit values of the one or more packets transmitted from the sender network node to the receiver network node of the network node pair. The one or more bits of the one or more packets may be set (or “marked”) to a predetermined value by one or more forwarding network nodes that forwards the one or more packets from the sender network node to the receiver network node of the network node pair, if the one or more forwarding network nodes experience congestion when the one or more packets travers it. The purpose of marking the packet (called “marked packet”) is to inform the receiving network node of impending congestion. For example, a forwarding network node of the one or more forwarding network nodes may mark a received packet (i.e., a packet sent by the sender network node to the receiver network node) if the packet queue length of the forwarding network node is higher than a threshold.

The information about congestion of the network node pair may comprise a congestion level associated with the traversal of the packets between the sender network node and the receiver network node of the network node pair. The congestion level may be determined by the receiver network node of the network node pair. The congestion level may be indicative of a fraction of packets received by the receiving network node from the sender network node of the network node pair, wherein each packet belonging to the fraction of packets comprises a congestion indication indicating that the packet has been forwarded by one or more forwarding network nodes that experienced congestion. In other words, the packets comprised in the fraction of packets are “marked packets”. The congestion level may be a percentage value. For example, if the receiving network node receives one “marked packet” out of 10 received packets, the receiving network node determines a congestion level of 10%.

The method 400 further comprises transmitting 403 the information about congestion of the network node pair to a computing device 101. The method 400 may further comprise transmitting an identifier of the network node pair. The identifier may uniquely identify the network node pair. The identifier may be a human-readable name or an alphanumeric name. The identifier may be a sender and receiver tuple identifier, such as (sender-address, sender-port, receiver-address, receiver-port).

The information about congestion of the network node pair may be transmitted periodically and/or when the congestion level of the network node pair changes.

It will be appreciated that the method 400 may comprise additional, alternative, or modified, steps in accordance with what is described throughout this disclosure.

More information on the congestion indication is provided in the following. As described above, the congestion indication may comprise ECN bit values. ECN is a congestion notification/signaling algorithm which, instead of dropping a packet like in conventional TCP/IP network signal congestion, is based on marking, by an ECN-aware router (i.e., a forwarding network node) the IP header of the packet to signal impending congestion when the average queue length of the ECN-aware router exceeds a threshold value. When the (endpoint) receiver network node receives the “marked packet”, it echoes the congestion indication to the (endpoint) sender network node, which will reduce its data transmission rate as if it detected a dropped packet. The two least significant (right-most) bits of the Traffic Class field in the IPv4 or IPv6 header are used to encode four different code points:
“00” indicates a non-ECN-Capable Transport (ECT) packet, i.e., the packet is not ECN supported. This means that the packet should not be marked in case of congestion, but it must be dropped;
“10” and “01”, referred as ECT(1) and ECT(0) respectively, indicate an ECT packet. These bits are set by the sender network node to indicate that the endpoints of the transport protocol (i.e., sender network node and receiver network node of a network node pair) are ECN-capable. Forwarding network nodes treat the ECT(0) and ECT(1) codepoints as equivalent;
“11”, referred as CE (Congestion Encountered) indicates an ECT packet that encountered congestion. When a forwarding network node traversed by a packet is congested and the packet is ECT enabled then the forwarding network node will mark this packet as CE.

Further information on ECN may be found in Internet Engineering Task Force (IETF) RFC 4774 (2006).

When the (endpoint) receiver network node receives a packet with “Congestion Encountered, CE” in the IP header, instead of notifying the (endpoint) sender network node in a TCP ACK packet returned, an embodiment of the (endpoint) receiver network node transmits to the computing device 101 information indicating that there is a congestion (i.e., the congestion indication).

According to an alternative embodiment, the congestion indication may comprise L4S bit values. L4S is a congestion notification/signaling algorithm based on ECN, where the ECN codepoints ECT(1) is used. An L4S-capable forwarding network node marks a traversing packet if the queue delay is higher than a threshold, wherein the threshold is lower than the one used by ECN-capable forwarding network nodes, Alternatively, if the queue at the forwarding network node has a certain length, the forwarding network node marks a proportional number of packets. Compared to ECN, the L4S approach gives more congestion events, provides lower delay jitter, and makes it possible to have very low queue delays while maintaining high link utilization. Further information on L4S may be found in IETF RFC 9330 (2023).

When a (endpoint) receiver network node receives an ECT(1) packet, instead of notifying the (endpoint) sender network node, the (endpoint) receiver network node transmits to the computing device 101 information indicating that there is a congestion (i.e., the congestion indication) according to embodiments.

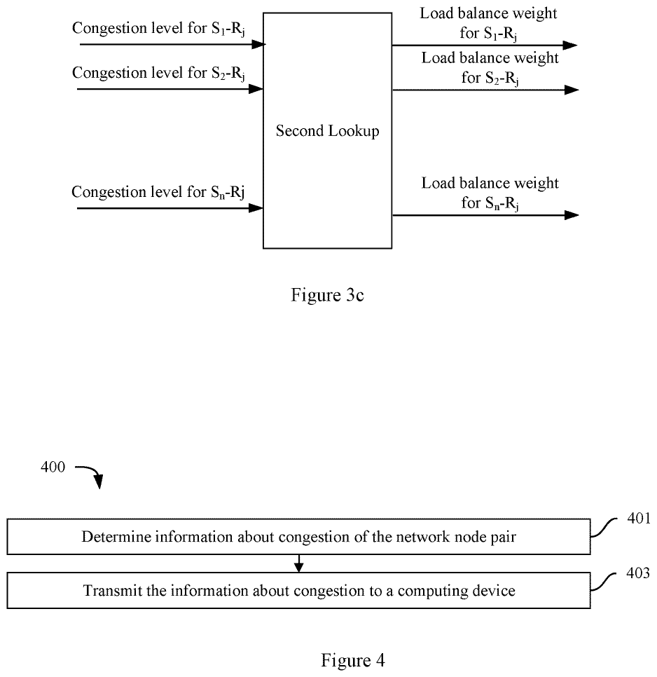

FIG. 5 shows a sequence diagram with messages exchanged between a computing device 101 for supporting congestion control, an instance 107a of a first microservice A of an application, a first network proxy 109a coupled with the instance of A, an instance 107d of a second microservice B of the application, a second network proxy 109d coupled with the instance of B, and forwarding network nodes, 111a, 111c, 111e. The sequence diagram shows for sake of simplicity only one instance per microservice, but there could be multiple instances per microservice.

With reference to FIG. 5, the messages exchanged are described in the following:
501: the instance 107a of A transmits data that is intercepted by the first network proxy 109a;
503: the first network proxy 109 determines a data transmission rate to transmit the data;
505: the instance 107a of A may experience a backpressure if the data transmission rate of the first network proxy 109a is lower than the data transmission rate of the instance 107a of A;
507: the first network proxy 109a transmits the data to the instance 107d of B, by forwarding the data to the first forwarding network node 111a along the path 111a, 111c, 111e connecting the instance 107a of A to the instance 107d of B;
509: the forwarding network nodes 111a, 111c, 111e along the path connecting the instance of A to the instance of B may mark one or more packets of the data if the forwarding network nodes 111a, 111c, 111e experience congestion when the one or more packets traverse them;
511: the forwarding network nodes 111a, 111c, 111e forward the data;
513: the second network proxy receives the data with marked and unmarked packets and generates 401 information about congestion for the network node pair comprising the first network proxy and the second network proxy, based on the marked packets received;
515: the second network proxy forwards the data to the instance of B;
517: the second network proxy transmits 403 to the computing device 101 the information about congestion for the network node pair comprising the first network proxy and the second network proxy and an identifier of the network node pair (pair ID);
519: the computing device 101 determines 203 a data transmission rate value for the first network proxy based on the information about congestion of the network node pair and further network node pairs (not shown in FIGS. 5),
520: the computing device 101 determines 203 a load balance weight for the network node pair comprising the first network proxy and the second network proxy based on the information about congestion of the network node pair and further network node pairs (not shown in FIG. 5);
521: the computing device 101 transmits 205 the data transmission rate value and/or the load balance weight to the first network proxy;
523, 525: the first network proxy configures its data transmission rate value and/or the load balance weight to transmit the data towards the second network node based on the received data transmission rate value and/or the load balance weight.

An example scenario in which a solution according to embodiments of the invention may be implemented is an eCommerce application where operations of a customer may comprise adding, updating, and removing, items to/in a cart. The eCommerce application may be built based on a microservice architecture. The microservices may be product catalogs (to process the available products), advertisement services (to advertise the products), shopping carts (to list the ordered products), user profiles (to process the user profile), authentication services (to authenticate the user), payment services (to process the payment based on the credit card details), or the like.

Each microservice may have multiple instances. A network proxy of a service mesh may be executed in parallel with each instance of each microservice. The network proxies intercepting data exchanged between the microservices are operative in accordance with embodiments of the invention described herein, in particular with reference to FIG. 4. The network proxies communicate with a computing device 101 according to embodiments of the invention described herein, in particular with reference to FIG. 2.

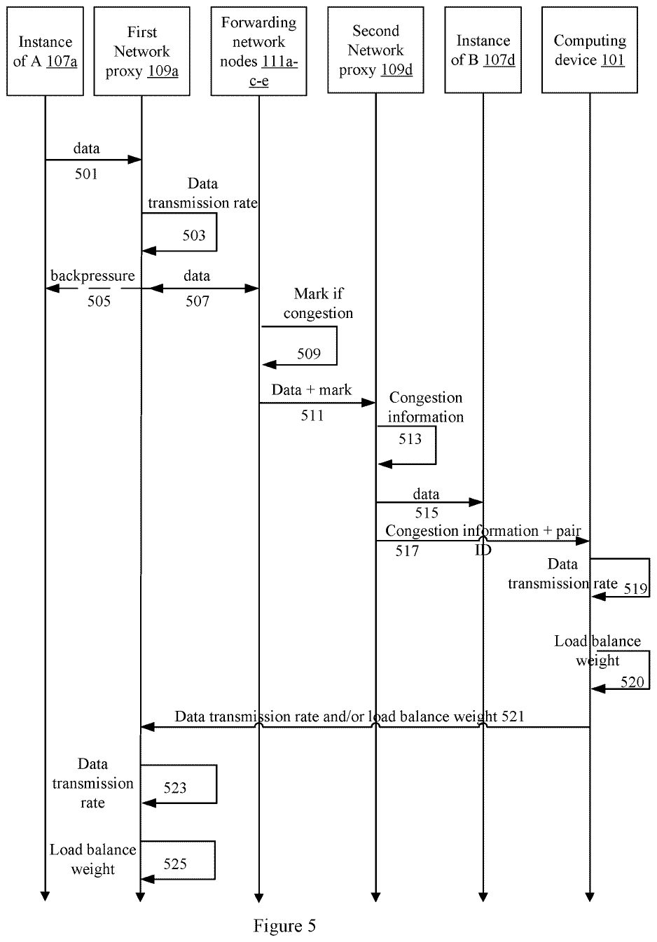

FIGS. 6a and 6b show, for the sake of simplicity, three microservices of the eCommerce application: product catalog (“product catalog”) 103e, advertisement service (“ad service”) 103c, and shopping cart (“cart”) 103d. Each microservice has three instances (“ad service” has instance1A 107g, instance2A 107h, instance3A 109i, “cart” has instance1B 107l, instance2B 107m, instance 3B 107n, “product catalog” has instance1C 107o, instance2 107p, instance3C 107q). The instances in “ad service” and the instances in “cart” can send requests to any instance in “product catalog”. Each instance is coupled with a network proxy that intercept all the traffic to and from the instance (instance1A, instance2A, instance3A is coupled with proxy1A 109g, proxy2A 109h, proxy3A 109i, respectively, instance1B, instance2B, instance3B is coupled with proxy1B 109l, proxy2B 109m, proxy 3B 109n, respectively, instance1C, instance2C, instance3C is coupled with proxy1C 109o, proxy2C 109p, proxy3C 109q, respectively).

In FIG. 6a, a congestion situation is shown, where one instance of “ad service” (instance1A 107g) and two instances of “cart” (instance1B 107l and instance2B 107n) are sending requests (601a, 603a, 605a) to the same instance of “product catalog” (instance1C 107o), thus generating congestion. In this congestion situation, Proxy1C lo in the “product catalog” service 103e
generates 401 information about congestion of the network node pairs (proxy1A-proxy 1C, proxy1B-proxy1C, proxy2B-proxy1C). For example, if proxy1C 109o receives one “marked packet” out of 10 packets, proxy 1C determines a congestion level of 10%, and
transmits 403, 607 the information about congestion to the computing device 101.

The computing device 101 determines 203 and transmits 609, 611, 613 a data transmission rate value for each sender network node of each network node pair, and/or a load balance weight for each of the two or more network node pairs based on the information about congestion. In this example, the computing device 101 may change the load balance weight so that Proxy1B of “cart” transmits its data 603b to Proxy2C of “product catalog”, Proxy2B of “cart” transmits its data 605b to Proxy3C of “product catalog”, and Proxy1A will keep sending its data 601a to Proxy 1C of “product catalog”, as shown in FIG. 6b. Note that
the instances (instance1A-3A, instance1B-3B, instance1C-3C) are not aware of the congestion control process since the computing device 101 only communicates with the network proxies (proxy1A-3A, proxy1B-3B, proxy1C-3C) of the service mesh, and
the computing device 101 may take a coordinated and global decision on the data transmission rate value for each sender network node of each network node pair, and/or a load balance weight for each of the two or more network node pairs, since it has congestion information of the two or more network node pairs.

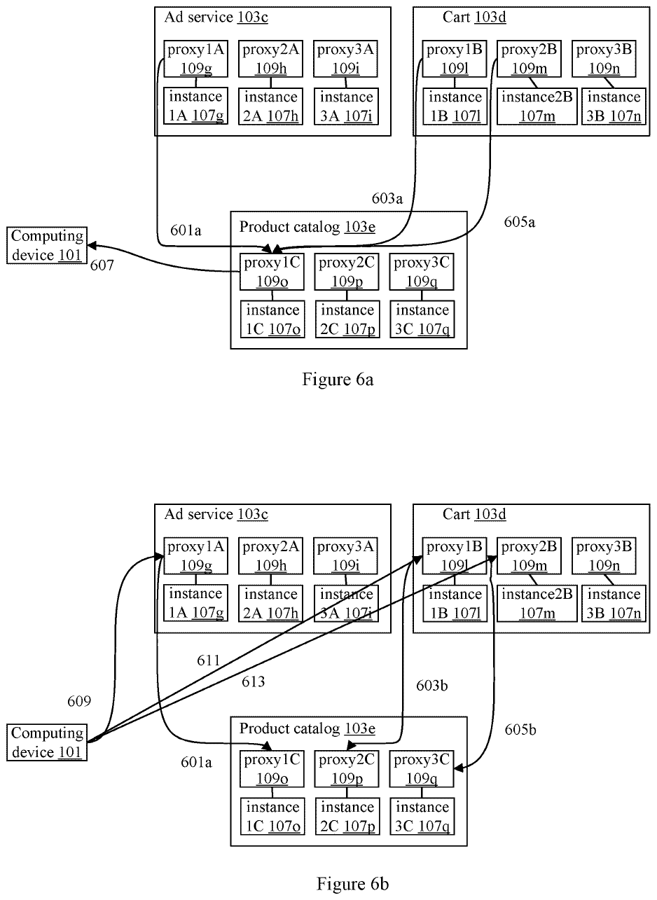

FIG. 7 shows a block diagram illustrating an embodiment of a computing device 101 comprising processor circuitry 701, a computer-readable data carrier, such as the memory 702, and the network interface circuitry 703. The computing device may be a router, gateway, Internet of Things (IoT) gateway, or any device with computing, storage, and network connectivity.

The processing circuitry 701 may comprise one or more processors, such as Central Processing Units (CPUs), microprocessors, application processors, application-specific processors, Graphics Processing Units (GPUs), and Digital Signal Processors (DSPs) including image processors, or a combination thereof, and the memory 702 comprises the computer program comprising instructions. When executed by the processor(s), the instructions cause the computing device 101 to become operative in accordance with embodiments of the invention described herein, in particular with reference to FIG. 2.

More specifically, the computing device 101 becomes operative to obtain 201 information about congestion of two or more network node pairs. Each network node pair comprises a sender network node of the two or more sender network nodes and a receiver network node of the two or more receiver network nodes. The information about congestion of a network node pair of the two or more network node pairs is based on a congestion indication comprised in packets transmitted between the sender network node and the receiver network node of the network node pair and is obtained from the receiver network node.

The computing device 101 becomes further operative to determine 203 a data transmission rate value for each sender network node of each network node pair, and/or a load balance weight for each of the two or more network node pairs based on the information about congestion of the two or more network node pairs. The load balance weight for a network node pair indicates a portion of a total traffic of the sender network node of the network node pair to be transmitted by the sender network node to the receiver node of the network node pair.

The computing device 101 becomes further operative to transmit 205 the data transmission rate value and/or the load balance weight to each sender network node of each of the two or more network node pairs.

According to an embodiment, the information about congestion of a network node pair comprises a congestion level associated with the traversal of packets between the sender network node and the receiver network node of the network node pair. The congestion level is indicative of a fraction of packets received by the receiving network node from the sender network node, and which comprise a congestion indication.

The computing device 101 may become further operative to determine a data transmission rate value for each sender network node of each network node pair and/or a load balance weight for each of the two or more network node pairs, by implementing 207 a feedback control system. The feedback control system comprises a first controller 301, a second controller 303, and a plant 305. The plant 305 comprises the two or more network node pairs. The first controller takes as input a value indicating a first threshold condition associated with a performance parameter of a network node pair of the two or more network node pairs and a load balance weight for each network node pair of the two or more network node pairs. The second controller 303 takes as input a current performance parameter of the network node pair of the two or more network node pairs and a second threshold condition associated with the performance parameter. The computing device 101 may become further operative to determine a data transmission rate value for each sender network node of each network node pair and/or a load balance weight for each of the two or more network node pairs, by, for each network node pair, changing 209 the data transmission rate if the performance parameter associated with the network node pair fulfills the first threshold condition and/or the load balance weight for the network node pair if the performance parameter associated with the network node pair fulfills the second threshold condition.

Alternatively, the computing device 101 may become further operative to determine a data transmission rate value for each sender network node of each network node pair and/or a load balance weight for each of the two or more network node pairs, by applying 211 a regression model to determine a first relationship between the two or more sender network nodes of the two or more network node pairs and the congestion level of the two or more network node pairs, and/or by applying 212 a regression model to determine a second relationship between the two or more receiving network nodes of the two or more network node pairs and the congestion level of the two or more network node pairs. The computing device 101 may become further operative to determine a data transmission rate value for each sender network node of each network node pair and/or a load balance weight for each of the two or more network node pairs, by changing 215 the data transmission rate value for the sender network node of each network node pairs based on the first relationship, and/or the load balance weight for each of the two or more network node pairs based on the second relationship.

Alternatively, the computing device 101 may become further operative to determine a data transmission rate value for each sender network node of each network node pair and/or a load balance weight for each of the two or more network node pairs, by applying 217 a machine learning model for adjusting the load balance weight for each of the two or more network node pairs.

Alternatively, the computing device 101 may become further operative to determine a data transmission rate value for each sender network node of each network node pair and/or a load balance weight for each of the two or more network node pairs, by changing 219 the data transmission rate value and/or the load balance weight based on at least one of:
a congestion threshold condition, wherein if the congestion level associated with a network node pair fulfills the congestion threshold condition, the data transmission rate value and/or the load balance weight is/are changed;
a first rule for increasing or decreasing the data transmission rate value and/or a second rule for increasing or decreasing the load balance weight;
a frequency indicating how often to change the data transmission rate value and/or the load balance weight;
a maximum and/or minimum value of the data transmission rate value and/or the load balance weight; and
a priority associated with each sender network node indicating an order in which the data transmission rate values of the two or more sender network nodes are changed, and/or a priority associated with each of the two or more network node pairs indicating an order in which the load balance weights of the two or more network node pairs is/are changed.

According to an embodiment, the MP2MP, communications network is a service mesh comprising network proxies associated with services of an application and a set of task management processes.

According to an embodiment, the congestion indication comprised in the packets comprises L4S or ECN bit values.

The computer program 704 may be stored in a computer-readable data carrier, such as a memory 702. Alternatively, the computer program 804 may be carried by a data carrier signal, e.g., downloaded to the memory 702 via a network interface circuitry 703. The memory 702 may, e.g., be a Random-Access Memory (RAM), a Read-Only Memory (ROM), a Flash memory, or the like. The computer program 704 may be downloaded to the memory 702 by means of the network interface circuitry 703, as a data carrier signal carrying the computer program 704. The network interface circuitry 703 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the computing device 101 and the receiver network node, the computing device 101 and the sender network node, and the computing device 101 and other computing devices, communications devices, a radio-access network, and/or the Internet. The processing circuitry 701 may alternatively or additionally comprise one or more Application-Specific Integrated Circuits (ASICs), Field-Programmable Gate Arrays (FPGAs), or the like, which are operative to cause the computing device 101 to become operative in accordance with embodiments of the invention described herein.

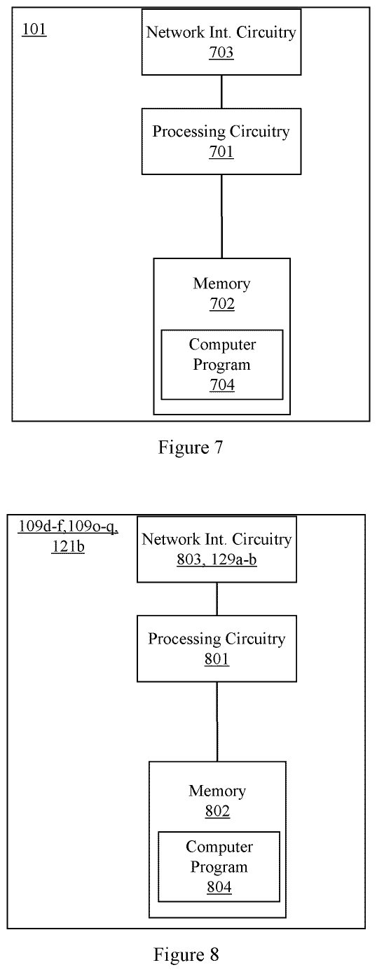

FIG. 8 shows a block diagram illustrating an embodiment of a receiver network node 109d-f, 109o-q, 121b, comprising processor circuitry 801, a computer-readable data carrier, such as the memory 802, and the network interface circuitry 803. The receiver network node may be a router, gateway, IoT gateway, or any device with computing, storage, and network connectivity. The receiver network node may be implemented as a virtual network node, such as a virtual switch or a virtual proxy, that can be executed in a data center.

The processing circuitry 801 may comprise one or more processors, such as CPUs, microprocessors, application processors, application-specific processors, GPUs, and DSPs including image processors, or a combination thereof, and the memory 802 comprising the computer program comprising instructions. When executed by the processor(s), the instructions cause the receiver network node to become operative in accordance with embodiments of the invention described herein, in particular with reference to FIG. 4.

More specifically, the receiver network node becomes operative to generate 401 information about congestion of the network node pair. The information about congestion of the network node pair is based on a congestion indication comprised in packets transmitted between the sender network node and the receiver network node of the network node pair. The receiver network node becomes further operative to transmit 403 the information about congestion to a computing device 101.

According to an embodiment, the information about congestion comprises a congestion level associated with the traversal of packets between the sender network node and the receiver network node of the network node pair. The congestion level is indicative of a fraction of packets received by the receiving network node from the sender network node, and which comprise a congestion indication.

According to a further embodiment, the congestion indication comprised in the packets comprises L4S or ECN bit values.

According to a further embodiment, the two or more sender network nodes and the two or more receiver network nodes are network proxies of a service mesh comprising network proxies associated with services of an application and a set of task management processes.

The computer program 804 may be stored in a computer-readable data carrier, such as a memory 802. Alternatively, the computer program 804 may be carried by a data carrier signal, e.g., downloaded to the memory 802 via a network interface circuitry 803. The memory 802 may, e.g., be a RAM, a ROM, a Flash memory, or the like. The computer program 804 may be downloaded to the memory 802 by means of the network interface circuitry 803, as a data carrier signal carrying the computer program 804. The network interface circuitry 803 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the receiver network node and the computing device 101 and other computing devices, communications devices, a radio-access network, and/or the Internet. The processing circuitry 801 may alternatively or additionally comprise one or more ASICS, FPGAs, or the like, which are operative to cause the computing device 101 to become operative in accordance with embodiments of the invention described herein.

The computing device 101 may communicate with the one or more receiver network nodes and with the one or more sender network nodes, through a subscription protocol, such as message queuing telemetry transport (MQTT) protocol, Open Platform Communications Unified Architecture (OPC-UA), Data Distribution Service (DDS), or utilizing any one of a number of transfer protocols, e.g., frame relay, internet protocol (IP), transmission control protocol (TCP), user datagram protocol (UDP), hypertext transfer protocol (HTTP), or by using Remote Procedure Call (RPC) protocols, such as gRPC, or Dynamic Resource Discovery (xDS) protocol. For example, the data transmission rate value and/or the load balance weight may be sent from the computing device 101 to the sender network node as a content of a “POST” HTTP message. The receiver network node may send the generated information about congestion to the computing device 101 as a content of a “POST” HTTP message.

1. A method for supporting congestion control in a multi-point-to-multi-point, MP2MP, communications network comprising two or more sender network nodes and two or more receiver network nodes, the method performed by a computing device and comprising:
obtaining information about congestion of two or more network node pairs, each network node pair comprising a sender network node of the two or more sender network nodes and a receiver network node of the two or more receiver network nodes, wherein the information about congestion of a network node pair of the two or more network node pairs is based on a congestion indication comprised in packets transmitted between the sender network node and the receiver network node of the network node pair and is obtained from the receiver network node;
determining a data transmission rate value for each sender network node of each network node pair,
and/or a load balance weight for each of the two or more network node pairs based on the information about congestion of the two or more network node pairs, wherein the load balance weight for a network node pair indicates a portion of a total traffic of the sender network node of the network node pair to be transmitted by the sender network node to the receiver node of the network node pair; and
transmitting the data transmission rate value and/or the load balance weight to each sender network node of each of the two or more network node pairs.

2. The method according to claim 1, wherein the information about congestion of a network node pair comprises a congestion level associated with the traversal of packets between the sender network node and the receiver network node of the network node pair, wherein the congestion level is indicative of a fraction of packets received by the receiving network node from the sender network node and which comprise a congestion indication.

3. The method according to claim 1, wherein the determining a data transmission rate value for each sender network node of each network node pair and/or a load balance weight for each of the two or more network node pairs further comprises:
implementing a feedback control system comprising a first controller, a second controller, and a plant, wherein the plant comprises the two or more network node pairs, and wherein the first controller takes as input a value indicating a first threshold condition associated with a performance parameter of a network node pair of the two or more network node pairs and a load balance weight for each network node pair of the two or more network node pairs, and wherein the second controller takes as input a current performance parameter of the network node pair of the two or more network node pairs and a second threshold condition associated with the performance parameter; and
for each network node pair, changing the data transmission rate if the performance parameter associated with the network node pair fulfills the first threshold condition and/or the load balance weight for the network node pair if the performance parameter associated with the network node pair fulfills the second threshold condition.

4. The method according to claim 2, wherein the determining a data transmission rate value for the sender network node of a network node pair and/or a load balance weight for each network node pair of the two or more network node pairs comprises:
applying a regression model to determine a first relationship between two or more receiver network nodes of two or more network node pairs sharing a same sender network node and the congestion level of the two or more network node pairs, and/or
applying a regression model to determine a second relationship between two or more sender network nodes of two or more network node pairs sharing a same receiver network node and the congestion level of the two or more network node pairs;
changing the data transmission rate value for the sender network node of each of the network node pairs sharing the same receiver network node based on the first relationship; and/or the load balance weight for each of the two or more network node pairs sharing the same sender network node based on the second relationship.

5. The method according to claim 1, wherein the determining a data transmission rate value for each sender network node of each network node pair and/or a load balance weight for each of the two or more network node pairs comprises:
applying a machine learning model for adjusting the load balance weight for each of the two or more network node pairs.

6. The method according to claim 2, wherein the determining a data transmission rate value for each sender network node of each network node pair and/or a load balance weight for each of the two or more network node pairs comprises:
changing the data transmission rate value and/or the load balance weight based on at least one of:
a congestion threshold condition, wherein if the congestion level associated with a network node pair fulfills the congestion threshold condition, the data transmission rate value and/or the load balance weight is/are changed;
a first rule for increasing or decreasing the data transmission rate value and/or a second rule for increasing or decreasing the load balance weight;
a frequency indicating how often to change the data transmission rate value and/or the load balance weight;
a maximum and/or minimum value of the data transmission rate value and/or the load balance weight;
a priority associated with each sender network node indicating an order in which the data transmission rate values of the two or more sender network nodes are changed, and/or a priority associated with each of the two or more network node pairs indicating an order in which the load balance weights of the two or more network node pairs is/are changed.

7. The method according to claim 1, wherein the sender network node and the receiver network node are network proxies of a service mesh comprising network proxies associated with services of an application and a set of task management processes.

8. The method according to claim 1, wherein the congestion indication comprised in the packets comprises Low Latency, Low Loss, Scalable Throughput, L4S, or Explicit Congestion Notification, ECN, bit values.

9. A method for supporting congestion control in a multi-point-to-multi-point, MP2MP, communications network, the method performed by a receiver network node of a network node pair of the MP2MP communications network and comprising:
generating information about congestion of the network node pair, wherein the information about congestion of the network node pair is based on a congestion indication comprised in packets transmitted between the sender network node and the receiver network node of the network node pair; and
transmitting the information about congestion to a computing device.

10. The method according to claim 9, wherein the information about congestion comprises a congestion level associated with the traversal of packets between the sender network node and the receiver network node of the network node pair, wherein the congestion level is indicative of a fraction of packets received by the receiving network node from the sender network node and which comprise a congestion indication.

11. The method according to claim 9, wherein the congestion indication comprised in the packets comprises Low Latency, Low Loss, Scalable Throughput, L4S, or Explicit Congestion Notification, ECN, bit values.

12. The method according to claim 9, wherein the two or more sender network nodes and the two or more receiver network nodes are network proxies of a service mesh comprising network proxies associated with services of an application and a set of task management processes.

13. A computing device for supporting congestion control in a multi-point-to-multi-point, MP2MP, communications network comprising two or more sender network nodes and two or more receiver network nodes, the computing device comprising a processor and a memory, the memory having stored thereon instructions executable by the processor, wherein the instructions, when executed by the processor, cause the computing device to:
obtain information about congestion of two or more network node pairs, each network node pair comprising a sender network node of the two or more sender network nodes and a receiver network node of the two or more receiver network nodes,
wherein the information about congestion of a network node pair of the two or more network node pairs is based on a congestion indication comprised in packets transmitted between the sender network node and the receiver network node of the network node pair and is obtained from the receiver network node;
determine a data transmission rate value for each sender network node of each network node pair, and/or a load balance weight for each of the two or more network node pairs based on the information about congestion, wherein the load balance weight for a network node pair indicates a portion of a total traffic of the sender network node of the network node pair to be transmitted by the sender network node to the receiver node of the network node pair; and
transmit the data transmission rate value and/or the load balance weight to each sender network node of each network node pair.

14. The computing device according to claim 13, wherein the information about congestion of a network node pair comprises a congestion level associated with the traversal of packets between the sender network node and the receiver network node of the network node pair, wherein the congestion level is indicative of a fraction of packets received by the receiving network node from the sender network node and which comprise a congestion indication.

15. The computing device according to claim 13, wherein the instructions cause the computing device to determine a data transmission rate value for each sender network node of each network node pair and/or a load balance weight for each of the two or more network node pairs, by:
implementing a feedback control system comprising a first controller, a second controller, and a plant, wherein the plant comprises the two or more network node pairs, and wherein the first controller takes as input a value indicating a first threshold condition associated with a performance parameter of a network node pair of the two or more network node pairs and a load balance weight for each network node pair of the two or more network node pairs, and wherein the second controller takes as input a current performance parameter of the network node pair of the two or more network node pairs and a second threshold condition associated with the performance parameter; and
for each network node pair, changing the data transmission rate if the performance parameter associated with the network node pair fulfills the first threshold condition and/or the load balance weight for the network node pair if the performance parameter associated with the network node pair fulfills the second threshold condition.

16. The computing device according to claim 14, wherein the instructions cause the computing device to determine a data transmission rate value for each sender network node of each network node pair and/or a load balance weight for each of the two or more network node pairs, by:
applying a regression model to determine a first relationship between the two or more receiver network nodes of the two or more network node pairs sharing a same sender network node and the congestion level of the two or more network node pairs, and/or
applying a regression model to determine a second relationship between two or more sender network nodes of two or more network node pairs sharing a same receiver network node and the congestion level of the two or more network node pairs;
changing the data transmission rate value for the sender network node of each network node pairs sharing the same receiver network node based on the first relationship;
and/or the load balance weight for each of the two or more network node pairs sharing the same sender network node based on the second relationship.

17. The computing device according to claim 13, wherein the instructions cause the computing device to determine a data transmission rate value for each sender network node of each network node pair and/or a load balance weight for each of the two or more network node pairs, by:
applying a machine learning model for adjusting the load balance weight for each of the two or more network node pairs.

18. The computing device according to claim 14, wherein the instructions cause the computing device to determine a data transmission rate value for each sender network node of each network node pair and/or a load balance weight for each of the two or more network node pairs, by:
changing the data transmission rate value and/or the load balance weight based on at least one of:
a congestion threshold condition, wherein if the congestion level associated with a network node pair fulfills the congestion threshold condition, the data transmission rate value and/or the load balance weight is/are changed;
a first rule for increasing or decreasing the data transmission rate value and/or a second rule for increasing or decreasing the load balance weight;
a frequency indicating how often to change the data transmission rate value and/or the load balance weight;
a maximum and/or minimum value of the data transmission rate value and/or the load balance weight;
a priority associated with each sender network node indicating an order in which the data transmission rate values of the two or more sender network nodes are changed, and/or a priority associated with each of the two or more network node pairs indicating an order in which the load balance weights of the two or more network node pairs is/are changed.

19-20. (canceled)

21. A receiver network node of a network node pair of a multi-point-to-multi-point, MP2MP, communications comprising two or more sender network nodes and two or more receiver network nodes, the receiver network node comprising a processor and a memory, the memory having stored thereon instructions executable by the processor, wherein the instructions, when executed by the processor, cause the receiver network node to:
generate information about congestion of the network node pair, wherein the information about congestion of the network node pair is based on a congestion indication comprised in packets transmitted between the sender network node and the receiver network node of the network node pair; and
transmit the information about congestion to a computing device.

22. The receiver network node according to claim 21, wherein the information about congestion comprises a congestion level associated with the traversal of packets between the sender network node and the receiver network node of the network node pair, wherein the congestion level is indicative of a fraction of packets received by the receiving network node from the sender network node and which comprise a congestion indication.

23-30. (canceled)
